(19) United States
(12) Patent Application Publication
(10) Pub. No.: US 2013/0027793 A1
(43) Pub. Date: Jan. 31, 2013

(54) Multiple Optical Beam Folding Apparatus and Method

(71) Applicant: UTAH STATE UNIVERSITY RESEARCH FOUND, North Logan, UT (US)

(72) Inventors: James C. Peterson, North Logan, UT (US); Alan B. Marchant, Hyrum, UT (US); Erik M. Stromberg, Logan, UT (US)

(73) Assignee: UTAH STATE UNIVERSITY RESEARCH FOUNDATION, North Logan, UT (US)

(21) Appl. No.: 13/647,213

(22) Filed: Oct. 8, 2012

Related U.S. Application Data
(63) Continuation-in-part of application No. 13/323,456, filed on Dec. 12, 2011.
(60) Provisional application No. 61/422,277, filed on Dec. 13, 2010.
(60) Provisional application No. 61/604,443, filed on Feb. 28, 2012.

(51) Int. Cl. G02B 5/08

(52) U.S. Cl. 359/851; 359/850

(57) ABSTRACT

A multiple optical beam folding apparatus for directing optical energy includes two or more radiation collectors configured to direct radiant energy through two or more independent optical paths to a shared focal plan array (FPA). The radiation collectors may include one or more gas cells or vacuum cells. One or more of the two or more optical paths may include a Galilean telescope. First and second reflecting surfaces are positioned in each of the two or more independent optical paths. The first reflecting surfaces are distinct reflecting surfaces from the second reflecting surfaces and the first and second reflecting surfaces are configured to direct the radiant energy of their respective independent optical paths to the FPA. The two or more second reflecting surfaces may be distinct surfaces of a pyramidal mirror.

### CROSS-REFERENCES TO RELATED APPLICATIONS

This application is a continuation-in-part application of U.S. patent application Ser. No. 13/323,456, entitled TRANSFERRING OPTICAL ENERGY, filed on Dec. 12, 2011; both the present application and application Ser. No. 13/323,456 claim priority to U.S. Provisional Patent Application No. 61/422,277, entitled SYSTEM AND METHOD FOR CAPTURING AND TRANSFERRING OPTICAL ENERGY, filed on Dec. 13, 2010, with inventors Blake Crowther and James C. Peterson; both application Ser. No. 13/323,456 and 61/422,277 are incorporated herein by reference in their entirety. This application also claims priority to U.S. Provisional Patent Application No. 61/604,443, filed Feb. 28, 2012 with inventors Blake Crowther and James C. Peterson, which is also incorporated herein by reference in its entirety.

### TECHNICAL FIELD

The present disclosure relates to a system and method for transferring energy from one optical system to another device, and in particular to a system and method for conveying an image from two or more telescopes to a single focal plane array (FPA).

### BRIEF SUMMARY

A multiple optical beam folding apparatus for directing optical energy is disclosed. The apparatus includes two or more radiation collectors configured to direct radiant energy through two or more independent optical paths. The radiation collectors may include one or more gas cells or vacuum cells. One or more of the two or more optical paths may include a Galilean telescope. First and second reflecting surfaces are positioned in each of the two or more independent optical paths. The first reflecting surfaces are distinct reflecting surfaces from the second reflecting surfaces and the first and second reflecting surfaces are configured to direct the radiant energy of their respective independent optical paths to a shared or single FPA. The two or more second reflecting surfaces may be distinct surfaces of a pyramidal mirror.

In other embodiments, the radiant energy includes chief rays that diverge as they encounter the shared FPA. Additionally, the two or more radiation collectors may be configured to collect radiant energy from a single scene or from multiple scenes. In another embodiment, each of the two or more independent optical paths forms an image of a scene on a separate or distinct area of the FPA. The FPA may include a contiguous region of pixels on one or more radiation detector devices. The contiguous region of pixels on the one or more radiation detector devices may be temperature stabilized within a single cooling chamber by a thermal control system. Locating the FPA within a single cooling chamber may reduce the number of parts, complexity, and energy required to operate the FPA because only a single area may be cooled as opposed to multiple areas. This is especially advantageous in space applications (e.g., at or above the mesosphere and into the exosphere) where energy required to run a spacecraft is at a premium.

In another embodiment, the multiple optical beam folding apparatus includes a baffle tube surrounding a length of one or more of the independent optical paths between the second reflecting surfaces and the focal plane array, or along other lengths of the independent optical path(s). Baffles or field stops may help restrict stray light. The baffle tube may surround a length of radiant energy within single optical path or multiple paths.

Additionally, one or more of the independent optical paths may include an intermediate focus. The apparatus may further include a field stop positioned near an intermediate focus of the one or more independent optical paths, the field stops configured to restrict illumination of their respective optical paths to non-overlapping regions of the focal plane array.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is an elevation view of an exemplary multiple optical beam folding apparatus;

FIG. 2 is an elevation view of another exemplary multiple optical beam folding apparatus;

FIG. 3 is an elevation view of a portion of an exemplary multiple optical beam folding apparatus;

FIGS. 4 and 5 are elevation views of a portion of an exemplary multiple optical beam folding apparatus;

FIG. 6 is a top-view of an exemplary multiple optical beam folding apparatus;

FIGS. 7a and 7b are top-views of exemplary focal plane arrays.

FIG. 8 is an isometric view of a Gas Filter Correlation Radiometer (GFCR) instrument containing an exemplary multiple optical beam folding apparatus;

FIG. 9 is a top view of the GFCR instrument of FIG. 7;

FIG. 10 is an isometric cut-away view of an exemplary multiple optical beam folding apparatus.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

The description of elements in each figure may refer to elements of proceeding figures. Like numbers refer to like elements in all figures, including alternate embodiments of like elements. The term radiant energy is equivalent to optical energy. In this description, the term “scene” refers to a spatially distributed source of optical radiance. The optical radiance may be emitted, transmitted, refracted, or scattered by the physical structures and materials of the scene. The term “image” refers to an irradiance pattern formed by intervening optics that is spatially similar to the scene and includes light from the scene. Multiple, distinct, optical systems may form distinct images of the scene and a single optical system may form multiple images of the same scene.

While specific embodiments and applications have been illustrated and described, it is to be understood that the disclosed invention is not limited to the precise configurations and components disclosed herein. The described embodiments are to be considered in all respects only as illustrative, and not restrictive. The present invention may be embodied in other specific forms without departing from its fundamental functions or essential characteristics. Various modifications, changes, and variations apparent to those of skill in the art may be made in the arrangement, operation, and details of the system of the present invention disclosed herein without departing from the spirit, scope, and underlying principles of the disclosure.

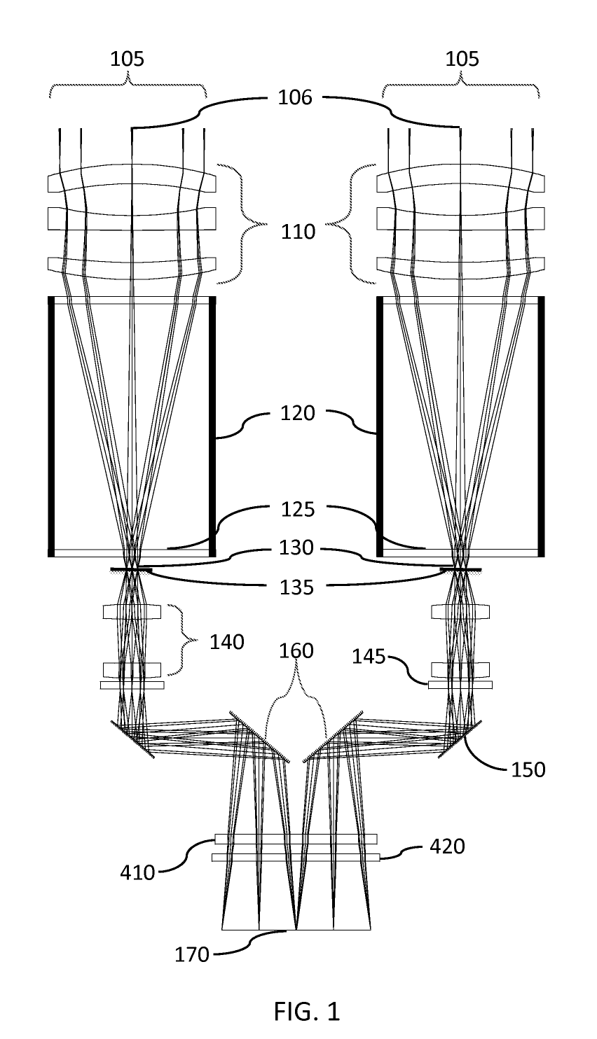

A multiple optical beam folding apparatus for directing optical energy includes two or more radiation collectors configured to direct radiant energy through two or more independent optical paths. First and second reflecting surfaces are positioned in each of the two or more independent optical paths to direct the radiant energy of their respective independent optical paths to a shared focal plane array. FIG. 1 is an elevation view of an exemplary multiple optical beam folding apparatus with independent optical paths of two beams of incoming radiant energy 105 in an exemplary plane. A multiple optical beam folding apparatus may include additional optical paths in other planes, e.g., perpendicular to the plane illustrated in FIG. 1. In this embodiment, radiant energy 105 may be guided through the objective lens groups 110 and directed through radiation collecting tubes 120. The collecting tubes 120 may contain a gas or a vacuum as described above. Radiant energy 105 may exit the collecting tubes 120 through a window 125 and may then pass through a field stop 135. Illustrated below the radiation collecting tubes 120, additional lens elements 140 may direct the radiant energy 105 along independent optical paths. The optical paths may continue to first reflecting surfaces 150. The first reflecting surfaces 150 may direct the radiant energy 105 to second reflecting surfaces 160 that are configured to direct the radiant energy of their respective independent optical paths to a shared FPA 170. In a preferred embodiment, radiant energy 105 reflects off distinct mirror surfaces of second reflecting surfaces 160, meaning that radiant energy 105 from one independent optical path does not overlap radiant energy 105 of another optical path on the second reflecting surfaces 160. In one embodiment, the radiant energy 105 may pass through a Dewar window 410 and a radiation filter 420 which may be included in a thermal control subsystem.

FIG. 1 also shows chief rays 106 of the radiant energy 105. Chief rays 106 are the collection of rays from the scene that pass through the center of each aperture or objective lens. Chief rays 106, located in the optical path between the second reflecting surfaces 160 and the FPA 170, may diverge as they encounter the FPA 170. Directing the radiant energy 105 in this manner may optimizes the space filled on the FPA 170 by radiant energy 105 while minimizing overlap between the respective images formed by the multiple optical paths. Alternatively, a baffle (not shown) may be used between the second reflecting surfaces 160 and the FPA 170. The baffle may be used in combination with one or more lenses (e.g., Dewar window 410, radiation filter 420, or other lenses) located between the second reflecting surfaces 160 and the FPA 170. In some embodiments, however, a baffle would tend to reduce the amount of radiant energy 105 reaching the FPA 170.

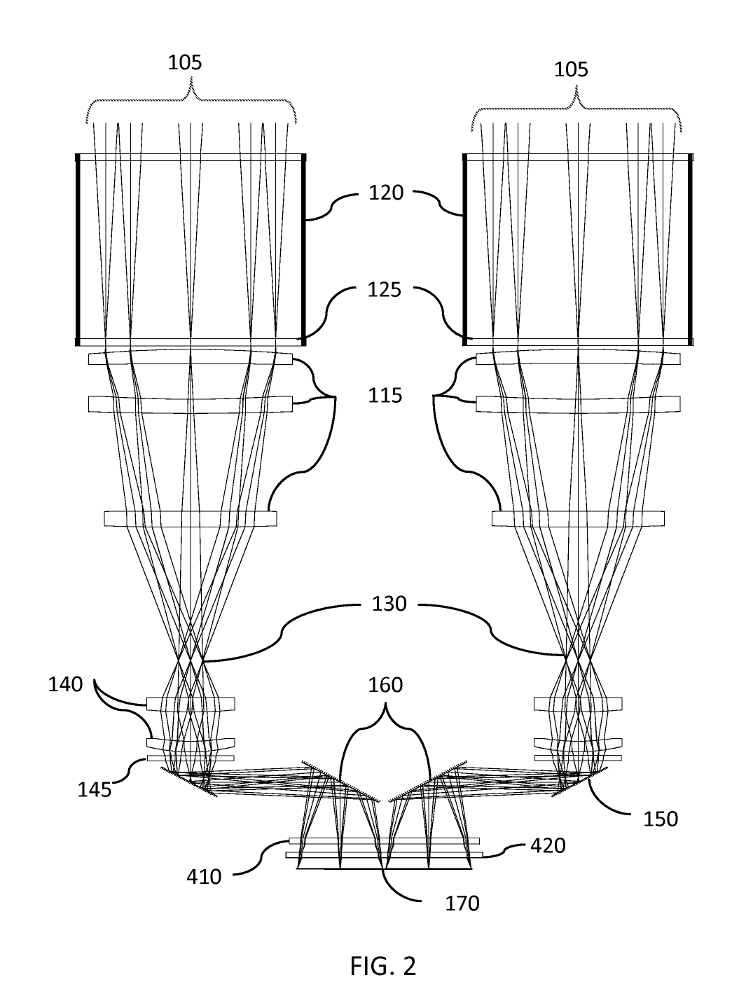

FIG. 2 is an elevation view of another exemplary multiple optical beam folding apparatus. FIG. 2 also illustrates the optical paths of two beams of incoming radiant energy 105 in one exemplary plane. In this embodiment, the incoming radiant energy 105 enters the first radiation collector 120, which may be a gas cell. The radiant energy 105 exits the radiation collector through a window 125. The radiant energy 105 then continues through a series of imaging optics 115. In an alternative embodiment, the imaging optics 115 may be a Galilean telescope.

After passing through the imaging optics 115, the radiant energy 105 may form an intermediate image 130 and continue along the optical path to a series of reimaging lenses 140. The reimaging lenses 140 may comprise reimaging lenses that reimage the intermediate images of the scene as images on the FPA 170. Alternatively, an optical path may include no intermediate image 130 while all the optical elements within an optical path cooperate to form a single image of the scene on the FPA 170. The reimaging optics may comprise lenses and a radiation filter 145. Radiant energy 105 from the independent optical paths that has passed through the reimaging optics 140 continues to the first reflecting surfaces 150 where the optical paths may be directed to second reflecting surfaces 160. The second reflecting surfaces 160 direct the radiant energy of the independent optical paths onto a single FPA 170. As in other embodiments, radiant energy 105 may reflect off distinct mirror surfaces of second reflecting surfaces 160 meaning that radiant energy 105 from one optical path does not overlap radiant energy 105 of another optical path on the second reflecting surfaces 160. The method of directing the radiant energy from independent optical paths to a single FPA 170 may be called “Optical Beam Folding”.

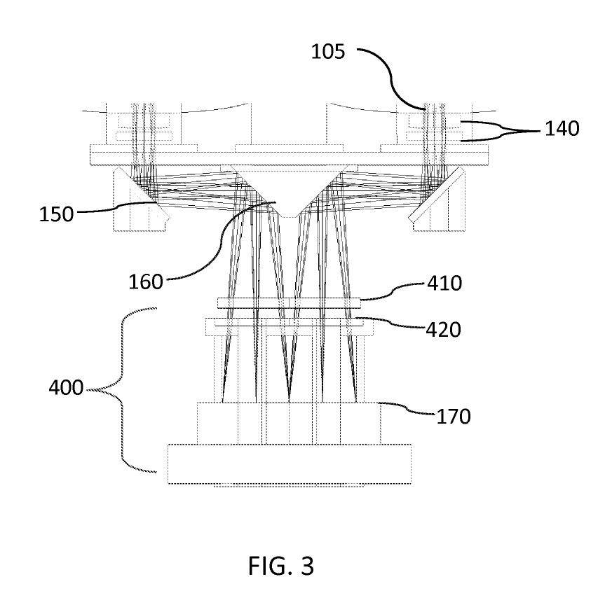

FIG. 3 is an alternate view of a beam folding technique as embodied in the apparatus of FIG. 1. Incoming radiant energy 105 from the independent optical paths is directed by first reflecting surfaces 150 onto second reflecting surfaces 160. The second reflecting surfaces 160 may be a pyramidal mirror. The radiant energy 105 may be projected from the second reflecting surface 160 into a thermally controlled chamber 400. The chamber 400 may include a window 410, a radiation filter 420, insulating walls (not shown), and an FPA 170.

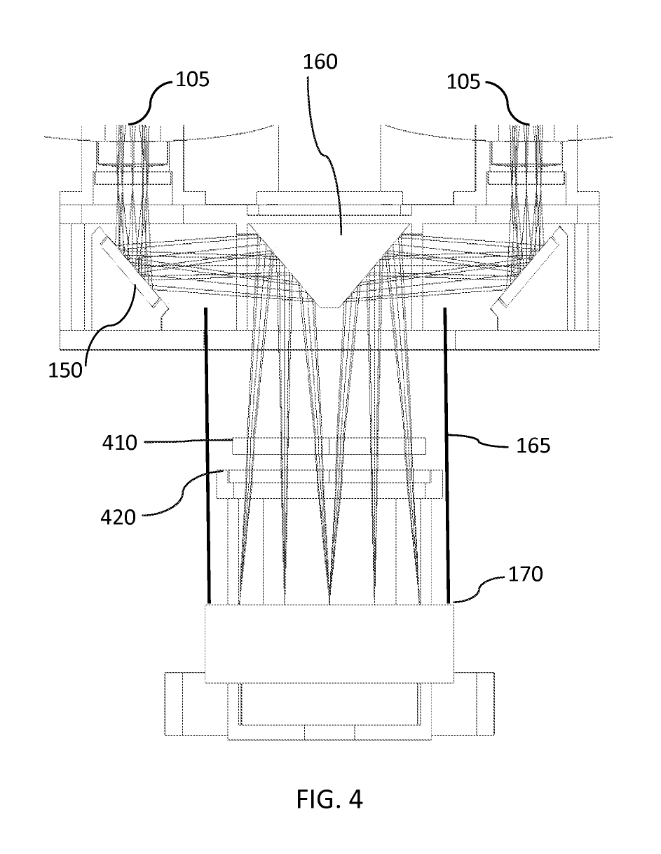

FIG. 4 illustrates an alternate embodiment incorporating a baffling tube 165 around radiant energy 105 in the optical path between the second reflecting surfaces 160 and the FPA 170. FIG. 5 illustrates baffling tubes 166 and 167 surrounding radiant energy 105a and 105b between second reflecting surfaces 160 and the FPA 170. In embodiments, a baffle tube may be useful in any location along any segment of the optical path or along the entire length of the optical path. A baffle tube may also be more useful for stray-light reduction in embodiments that do not have field stops at intermediate foci.

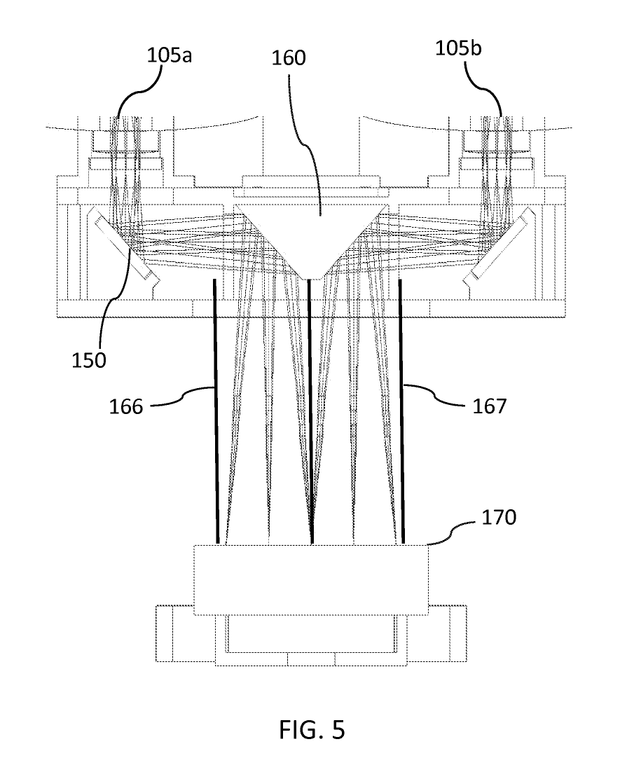

FIG. 6 is a top-view of an exemplary multiple optical beam folding apparatus. This view illustrates four radiation collectors 180a-180d and second reflecting surfaces 160a-160d. The radiation collectors 180 may include, but are not limited to, gas cells containing various gases of interest at different concentrations (as described above) and one or more imaging optics. The imaging optics may serve as a Galilean telescope. Radiant energy 105 (shown in previous figures) that enters each of the four radiation collectors 180a-180d may be directed onto first reflecting surfaces (not shown) and then secondary reflecting surfaces 160 and subsequently may be projected onto a single FPA (not shown).

FIG. 6 further illustrates how second reflecting surfaces 160a-160d may comprise distinct mirror surfaces. In this view, mirror surfaces of second reflecting surfaces 160a-160d are separated by a dashed line illustrating their distinctiveness. For example, radiant energy (not shown) directed through one radiation collector 180a reflects off reflecting surface 160a and does not overlap radiant energy directed through radiation collector 180b, which reflects off reflecting surface 160b toward the FPA (not shown). Additionally, the non-overlapping radiant energy may be projected onto non-overlapping regions or areas of the FPA.

While FIG. 6 illustrates four radiation collectors 180a-180d, a multiple optical beam folding apparatus may include more radiation collectors. For example, there may be 5, 6, 7, 8, 9, 10, or 20 or more radiation collectors. A corresponding number of first and second reflecting surfaces may direct the radiant energy from the multiple radiation collectors onto an FPA. For example, six radiation collectors may be arranged around the perimeter of a hexagonal or circular shape and the radiant energy from the six radiation collectors may be directed to six distinct first reflecting surfaces (also arranged around the perimeter of a hexagonal or circular shape) and then onto six distinct second reflecting surfaces.

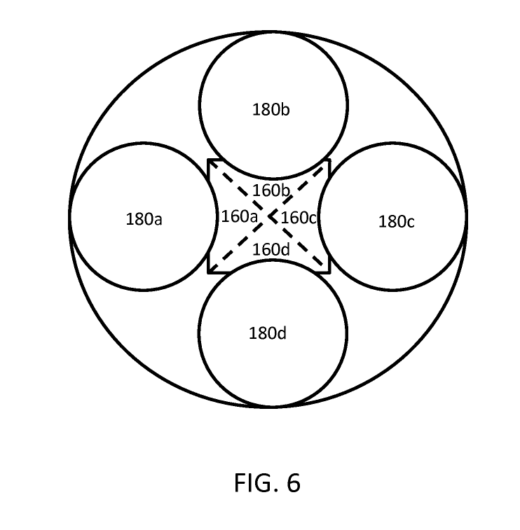

FIG. 7a illustrates an embodiment of individual radiation detectors 175a-175d joined together or abutted as an FPA 171. FIG. 7b illustrates a single radiation detector 172 logically divided into multiple segments or subarrays 176a-176d. In embodiments, the FPA 170 illustrated in FIGS. 1-5 could be FPA 171 in FIG. 7a or FPA 172 in FIG. 7b. In one embodiment, radiant energy passing through multiple radiation collectors, as shown by 180a-180d in FIG. 6, may be projected onto a shared FPA 171, comprising four single radiation detectors 175a-175d. In another embodiment, the FPA 172 may be a contiguous region of pixels from a single radiation detector device divided into multiple sub-regions, 176a-176d.

The contiguous region of pixels may be divided into additional segments depending on how many independent optical paths or images of radiant energy are directed onto the FPA 172. The shape of the images on 175a-175d or 176a-176d may be controlled by the shape of field stops, e.g., field stop 135 shown in FIG. 1 or other field stops in other locations along the optical path.

The multiple optical beam folding apparatus may be configured to restrict illumination of the respective optical paths to non-overlapping regions of the FPA 170, 171, or 172, e.g., 175a-175d or 176a-176d. Each individual radiation detector or segment of a contiguous region of pixels may measure the distinct or non-overlapping radiant energy transmitted through the independent optical paths. One advantage of the present apparatus is that the FPA 170, whether multiple radiation detectors joined as a single FPA 171 or a single radiation detector 171 with a contiguous region of pixels, may be located within a single cooling chamber and temperature stabilized to a uniform temperature by a common thermal control system. Locating the FPA within a single cooling chamber may reduce the number of parts, complexity, and energy required to operate the FPA because only a single area may be cooled as opposed to multiple areas. This is especially advantageous in space applications (e.g., at or above the mesosphere and into the exosphere) where energy required to run a spacecraft is at a premium.

A multiple optical beam folding apparatus, according to embodiments of the present disclosure, may be used within a Gas Filter Correlation Radiometer (GFCR) to direct radiant energy viewed by the GFCR to a shared focal plane array (FPA). A GFCR may be used to measure the concentration of an emitting or absorbing gas within a scene viewed by the GFCR.

A GFCR may include multiple gas cells, each containing a different concentration of a gas of interest. For example, a GFCR instrument may have two gas cells containing two different concentrations of Methane (CH₄), e.g., one gas cell may contain one atmosphere of CH₄ and a second gas cell may contain and two atmospheres of CH₄. A third gas cell may contain no gas and therefore be under vacuum pressure. CH₄, and other gases of interest, absorb radiant energy, or light, at specific frequencies in proportion to the amount of gas present in the optical path of the radiant energy. Therefore, a gas cell containing two atmospheres of CH₄ within an optical path of radiant energy will absorb more radiant energy at specific frequencies than a gas cell containing one atmosphere of CH₄ (or no atmospheres of CH₄) within the optical path.

A GFCR instrument may also contain various optical components, including the gas cells described above, for transferring radiant energy viewed or received by the GFCR to two or more focal plane arrays. The radiant energy may be directed to the focal plane arrays through independent optical paths. For example, there may be an independent optical path for radiant energy passing through each gas cell. A narrow-band spectral filter that limits the range of frequency to which the focal plane arrays can respond may influence the intensity of the radiant energy reaching the focal plane arrays.

A GFCR measures the concentration of a gas within a scene viewed by the GFCR by comparing the relative amount of radiant energy passing through the multiple gas cells and reaching the focal plane arrays. A multiple optical beam folding apparatus may be used in a GFCR to direct the radiant energy viewed by the GFCR to a single FPA.

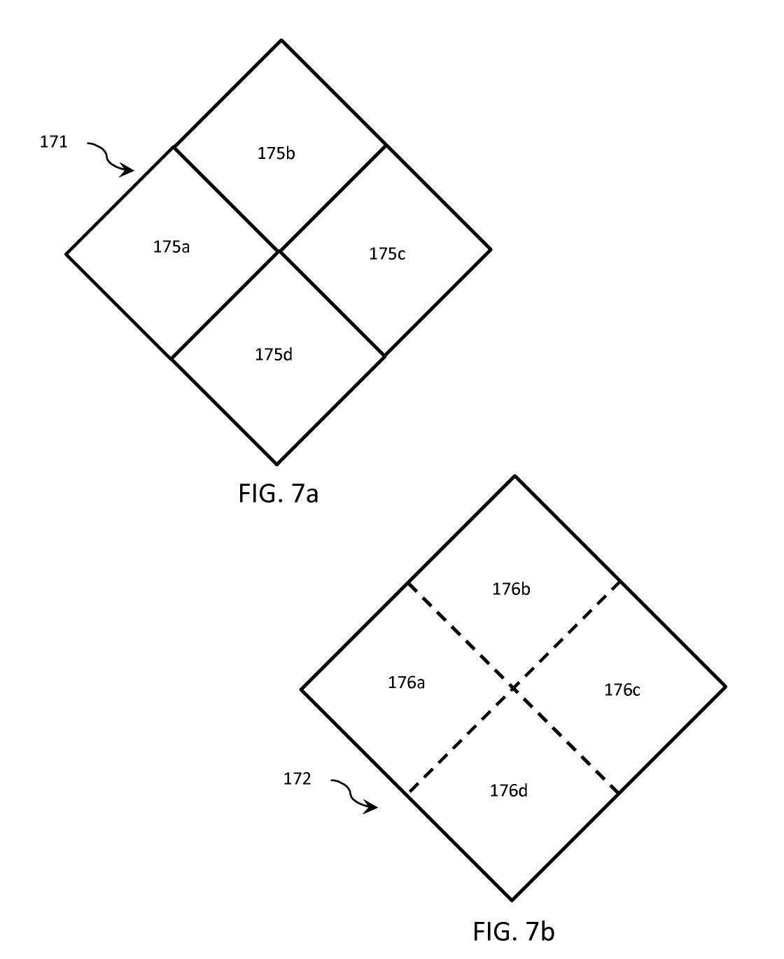

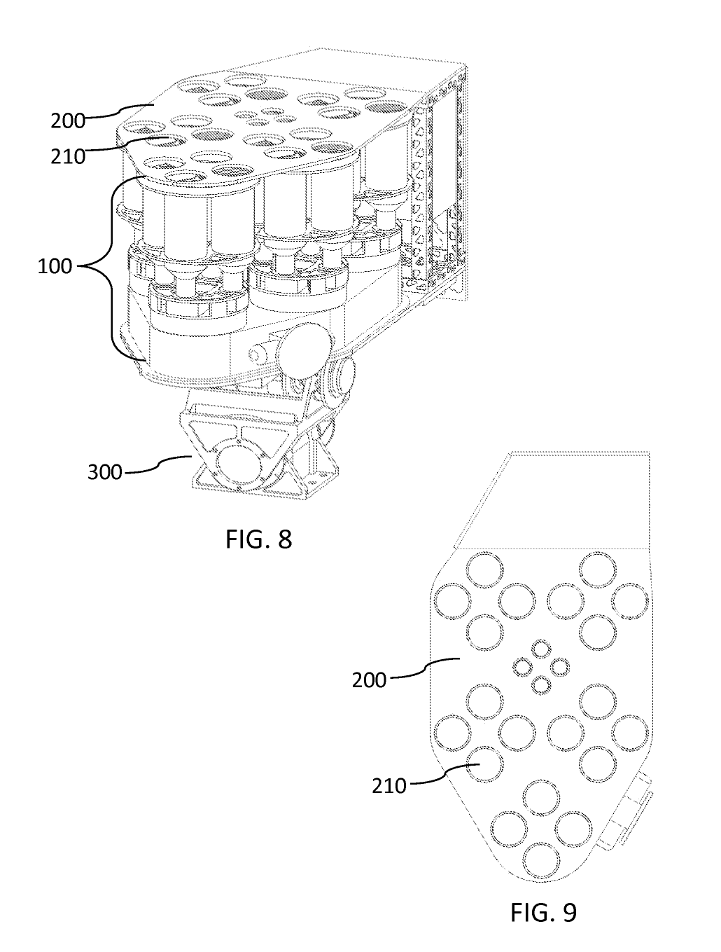

FIGS. 8 and 9 illustrate a GFCR containing multiple exemplary embodiments of a multiple optical beam folding apparatus 100. Some elements in FIGS. 8 and 9 may be part of the GFCR, while others may be part of the multiple optical beam folding apparatus and the GFCR. A multiple optical beam folding apparatus 100 includes two or more radiant energy collectors configured to direct radiant energy through two or more independent optical paths to a shared FPA (not shown). The radiant energy may be emitted, scattered, reflected, or diffracted, etc., from a scene of interest. The GFCR shown in FIGS. 8 and 9 include a top panel 200 with apertures 210. FIG. 8 also illustrates a two-axis gimbal 300 located at the base of the GFCR. The gimbal 300 enables the GFCR to position apertures 210 toward the scene to collect incoming radiant energy.

FIG. 9 illustrates a plan view of the GFCR with the top panel 200 and apertures 210. The apertures permit radiant energy to enter the multiple optical beam folding apparatus 100.

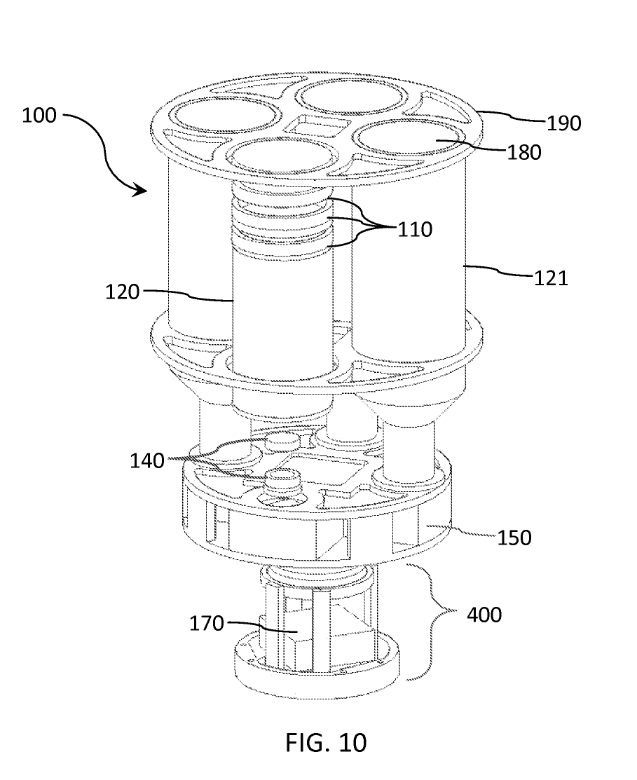

FIG. 10 is an isometric view of an exemplary multiple optical beam folding apparatus 100 with four radiation collectors 180. The center radiation collector in FIG. 10 is shown without a casing 120 to illustrate the optical components within the optical beam folding apparatus 100. This particular embodiment includes objective lenses 110 associated with radiation collectors 180. In the depicted embodiment, a radiation collecting tube 120 is located below objective lenses 110. The radiation collecting tubes 120 may contain a gas or multiple gasses of some concentration for comparison and reference. A gas cell may be a vacuum cell maintained at a vacuum pressure. Alternatively, the gas concentrations within the one or more gas cells may range from approximately 0 atmospheres (and thus be a vacuum cell) to 4 atmospheres, or more. For example, the gas concentration may be 0, 1, 2, 3, 4, or more atmospheres. A gas cell may contain a gas of interest, e.g., CH₄, N₂O, O₃, CO, HDO, or HCN.

FIG. 10 further illustrates one or more additional lens elements 140 located below the radiation collecting tubes 120. The additional lens elements, together with the objective lenses 110, may direct and focus incoming radiant energy to form images at the focal plane array (FPA 170). FIG. 10 also illustrates a housing 150 containing first and second reflecting surfaces (not shown). In embodiments, the FPA 170 resides within a thermally controlled chamber or a thermal control subsystem housing 400.

In the illustrated embodiments, four radiation collectors direct radiant energy through first and second reflecting surfaces to an FPA. In other embodiments, multiple multi-group radiation collectors may be combined with other multi-group radiation collectors to direct radiation within their respective optical paths to a single FPA array. For example, the radiation in the optical paths of two or more, multi-group radiation detectors may be directed to a single FPA. Referring back to FIG. 10, if the thermal subsystem housing 400 were removed, a third and fourth set of reflecting surfaces could be contained in another larger housing below housing 150. The third and fourth reflecting surfaces could direct radiant energy from four, four-group radiation collectors to a single FPA.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
two or more radiation collectors configured to direct radiant energy through two or more independent optical paths;
first and second reflecting surfaces positioned in each of the two or more independent optical paths, the first reflecting surfaces comprising distinct reflecting surfaces from the second reflecting surfaces and the first and second reflecting surfaces configured to direct the radiant energy of their respective independent optical paths to a shared focal plane array.

2. The apparatus of claim 1, wherein the radiant energy comprises chief rays that diverge as they encounter the shared focal plane array.

3. The apparatus of claim 1, wherein the two or more radiation collectors are configured to collect radiant energy from a single scene.

4. The apparatus of claim 1, wherein each of the two or more independent optical paths forms an image of a scene on the focal plane array.

5. The apparatus of claim 1, wherein the two or more radiation collectors are configured to collect radiant energy from multiple scenes.

6. The apparatus of claim 1, wherein the focal plane array comprises a contiguous region of pixels on one or more radiation detector devices.

7. The apparatus of claim 4, wherein the contiguous region of pixels is temperature stabilized by a thermal control system.

8. The apparatus of claim 1, further comprising a baffle tube surrounding a length of one or more independent optical paths.

9. The apparatus of claim 1, wherein one or more of the two or more independent optical paths includes one or more intermediate foci.

10. The apparatus of claim 9, further comprising one or more field stops positioned adjacent one or more intermediate foci, the one or more field stops configured to restrict illumination of two or more images to non-overlapping regions of the focal plane array.

11. The apparatus of claim 1, wherein the two or more second reflecting surfaces are distinct surfaces of a pyramidal mirror.

12. The apparatus of claim 11, wherein the pyramidal mirror comprises at least three reflective surfaces.

13. The apparatus of claim 1, wherein one or more of the two or more radiation collectors comprise a gas cell.

14. The apparatus of claim 1, wherein one or more of the two or more independent optical paths comprises a Galilean telescope.

15. The apparatus of claim 1, wherein the one or more radiation collectors comprise a vacuum cell.

16. A method for optical beam folding, the method comprising:
receiving radiation through two or more radiation collectors;
directing the radiation through two or more independent and distinct optical paths;
directing the radiation from each of the two or more independent and distinct optical paths onto first reflecting surfaces;
reflecting the radiation from each of the two or more independent and distinct optical paths from the first reflecting surfaces to second reflecting surfaces;
reflecting the radiation from each of the two or more independent optical paths from the second reflecting surfaces to a shared focal plane array, wherein radiation from a first independent and distinct optical path does not overlap radiation from a second independent and distinct optical path on a surface of the shared focal plane array.

17. The method of claim 16, further comprising:
diverging chief rays of the radiation from each of the two or more independent optical paths as the chief rays encounter the shared focal plane array.

18. The method of claim 16, wherein the step of reflecting the radiation from each of the two or more independent optical paths from the second reflecting surfaces to the shared focal plane array further comprises reflecting the radiation onto a contiguous region of pixels on one or more radiation detector devices.

19. The method of claim 18, further comprising temperature stabilizing the contiguous region of pixels.

20. The method of claim 16, further comprising directing the radiation from one or more of the two or more independent and distinct optical paths through one or more gas cells.
